(19) United States
(12) Patent Application Publication
(10) Pub. No.: US 2012/0316955 A1
(43) Pub. Date: Dec. 13, 2012

(54) System and Method for Mobile Application Search

(75) Inventors: Anil Panguluri, Milpitas, CA (US); Guy Hepworth, San Francisco, CA (US); Alice Han, San Mateo, CA (US); Polly Ng, Forest Hills, NY (US); Peng Liu, Beijing (CN); Xin Fan, Beijing (CN); Zhaohui Zheng, Mountain View, CA (US); Yuanyuan Wang, Beijing (CN)

(73) Assignee: YAHOO! INC., Sunnyvale, CA (US)

(21) Appl. No.: 13/441,119

(22) Filed: Apr. 6, 2012

Related U.S. Application Data
(60) Provisional application No. 61/472,510, filed on Apr. 6, 2011.

(51) Int. Cl. G06F 17/30; G06Q 30/06; G06Q 30/02

(52) U.S. Cl. 705/14.41; 707/769; 707/706; 705/14.54; 705/26.1; 707/E17.014

(57) ABSTRACT

Method, system, and programs for providing adaptive application searching are disclosed. An application search request relevant to a user is received. First information associated with the user and second information associated with a plurality of applications is obtained. At least one application of the plurality of applications is identified as of interest based on the application search request, the first information, and the second information. The at least one application is provided in response to the application search request.

### CROSS-REFERENCE TO RELATED APPLICATIONS

The present application claims the benefit of priority to U.S. Provisional Application Ser. No. 61/472,510 filed 6 Apr. 2011, which is incorporated herein by reference in its entirety.

### FIELD

The present disclosure relates to methods, systems and programming for searching applications. More particularly, the present disclosure is directed to methods, systems, and programming for providing mobile application recommendations.

### BACKGROUND OF THE INVENTION

With the current proliferation of smartphone, tablet, and other handheld device usage by consumers and businesses, users are increasingly looking to mobile applications from App stores to provide them with applications they need to take full advantage of their devices. However, most App stores do not offer recommendations that are adequate or even serviceable for all users. The iTunes store represents one example of App stores, where very often, searching for applications leads to a list of results with a few relevant results populating the beginning of the list and results deeper in the list being much less relevant and appearing in a random order. Another example of App stores, the Android Market, does not allow searching from a desktop computer and requires a user to search for applications on a handheld device screen, which may sometimes be less than ideal for browsing search results. Searching also produces inconsistent results as result lists often mix highly rated applications with low rated applications, leaving the user to take the time to sort through the applications. Yet another App store, Blackberry App World, returns excessive results that do not seem tailored to the search terms. Thus, current App stores do not tailor their search queries to provide applications to users based on user interests or provide personalization of application recommendations on the basis of user interests.

### SUMMARY

The embodiments disclosed herein relate to methods, systems, and programming for adaptive application searching.

In an embodiment, a method, implemented on a machine having at least one processor, storage, and a communication platform connected to a network for providing adaptive application searching is disclosed. An application search request relevant to a user is received. First information associated with the user and second information associated with a plurality of applications is obtained. At least one application of the plurality of applications is identified as of interest based on the application search request, the first information, and the second information. The at least one application is provided in response to the application search request.

In another embodiment, the application search request includes at least one of: a query originating from the user or an automatically initiated application search request.

In another embodiment, the first information includes at least one of: user device information, a profile associated with the user, trending data associated with the user, and past behavior data of the user with respect to usage of applications.

In another embodiment, providing the at least one application comprises filtering the identified at least one application based on criterion comprising at least one of: user social networking groups, user device location, user personal contacts, and user personal relationship data.

In another embodiment, the at least one application is caused to be automatically installed on a device associated with the user.

In an embodiment, a method, implemented on a machine having at least one processor, storage, and a communication platform connected to a network for presenting advertisements is disclosed. At least one application is selected based on user information. At least one advertisement is associated with at least one application. The at least one advertisement is provided for display when the at least one application is displayed in response to an application search query from a user associated with the user information.

In another embodiment, information related to presentation of the at least one advertisement associated with the at least one application is obtained. Statistics associated with the presentation are determined. A record associated with an advertiser is updated based on the statistics. A payment associated with the at least one advertisement is received based on the updated record.

In an embodiment, a method, implemented on a machine having at least one processor, storage, and a communication platform connected to a network for providing sponsored application searching is disclosed. First information associated with a user is obtained. Second information associated with at least one application provided by a sponsor is obtained. At least one application relevant to the user is selected based on the first information and the second information. Third information associated with activity of the user is obtained with respect to the selected at least one application. The third information is provided to the sponsor for analysis. A list of additional applications is provided to the user based on the analyzed third information.

In another embodiment, the sponsor is at least one of: an application developer, an application repository, an application distributor, and an application dealer.

In an embodiment, a method, implemented on a machine having at least one processor, storage, and a communication platform connected to a network for providing applications to a user is disclosed. First information associated with a user and second information associated with at least one application is analyzed. A subscription plan allowing the user to access the at least one application in accordance with predetermined terms is established based on the analyzing. The user is provided access to the at least one application based on the subscription plan.

In another embodiment, the predetermined terms comprise at least one of: a fee for the subscription plan, a number of applications allowed by the subscription plan, an incentive program, and awards to be provided based on conditions associated with usage of the applications.

In an embodiment a system providing adaptive application searching is disclosed. The system includes a search engine for receiving an application search request relevant to a user; a user database storing first information associated with the user; an application trend database storing second information associated with a plurality of applications, and an application search engine for identifying at least one application of the plurality of applications of interest based on the application search request, the first information and the second information, and providing the at least one application as a response to the application search request.

In another embodiment, the application search request includes at least one of: a query originating from the user or an automatically initiated application search request.

In another embodiment, the first information includes at least one of: user device information, a profile associated with the user, trending data associated with the user, and past behavior data of the user with respect to usage of applications.

In another embodiment, the application search engine is further configured for filtering the identified at least one application based on criterion comprising at least one of: user social networking groups, user device location, user personal contacts, and user personal relationship data.

In another embodiment, the application search engine is further configured for causing the at least one application to be automatically installed on a device associated with the user.

Other concepts relate to software for implementing adaptive application searching. A software product, in accord with this concept, includes at least one machine-readable non-transitory medium and information carried by the medium. The information carried by the medium may be executable program code data regarding parameters in association with a request or operational parameters.

In an embodiment, a machine readable and non-transitory medium having information recorded thereon for providing adaptive application searching, where when the information is read by the machine, causes the machine to receive an application search request relevant to a user, obtain first information associated with the user and second information associated with a plurality of applications, identify at least one application of the plurality of applications of interest based on the application search request, the first information, and the second information, and provide the at least one application as a response to the application search request.

In another embodiment, the application search request includes at least one of: a query originating from the user or an automatically initiated application search request.

In another embodiment, the first information includes at least one of: user device information, a profile associated with the user, trending data associated with the user, and past behavior data of the user with respect to usage of applications.

In another embodiment, providing the at least one application comprises filtering the identified at least one application based on criterion comprising at least one of: user social networking groups, user device location, user personal contacts, and user personal relationship data.

In another embodiment, the at least one application is caused to be automatically installed on a device associated with the user.

Additional advantages and novel features will be set forth in part in the description which follows, and in part will become apparent to those skilled in the art upon examination of the following and the accompanying figures or may be learned by production or operation of the embodiments described herein. The advantages of the embodiments described herein may be realized and attained by practice or use of various aspects of the methodologies, instrumentalities, and combinations set forth in the description below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings.

FIG. 1 depicts an exemplary prior art application search result list.

FIG. 2 depicts an exemplary application search result list in accordance with an embodiment of the present disclosure.

FIG. 3 depicts an exemplary application recommendation list in accordance with an embodiment of the present disclosure.

FIG. 4 depicts an exemplary application recommendation in accordance with an embodiment of the present disclosure.

FIG. 5 is a high level depiction of an exemplary system providing mobile application search results and recommendations, in accordance with an embodiment of the present disclosure.

FIG. 6 is a high level depiction of an exemplary system providing mobile application search results and recommendations, in accordance with an embodiment of the present disclosure.

FIG. 7 is a high level depiction of an exemplary system providing mobile application search results and recommendations, in accordance with an embodiment of the present disclosure.

FIG. 8 is a high level depiction of an exemplary system providing mobile application search results and recommendations, in accordance with an embodiment of the present disclosure.

FIG. 9 is a high level depiction of an exemplary system 900 showing the interaction between users, an application search engine, data sources, and third-party information provider, in accordance with an embodiment of the present disclosure.

FIG. 10 is a high level depiction of an exemplary application search layer, in accordance with an embodiment of the present disclosure.

FIG. 11 is a high level depiction of an exemplary search and recommendation layer, in accordance with an embodiment of the present disclosure.

FIG. 12 depicts a flowchart of an exemplary process in which an application search engine provides application search results to devices, in accordance with an embodiment of the present disclosure.

FIG. 13 depicts a flowchart of an exemplary process in which how an application search engine handles download of applications based on the application search result list, in accordance with an embodiment of the present disclosure.

FIG. 14 depicts an exemplary high level diagram of a system facilitating accounting associated with the download of applications, in accordance with an embodiment of the present disclosure.

FIG. 15 depicts a flowchart of an exemplary process in which an application search engine updates accounting records for third-party providers based on downloaded applications, in accordance with an embodiment of the present disclosure.

FIG. 16 depicts an exemplary screen view of an application search results list in accordance with an embodiment of the present disclosure.

FIG. 17 depicts an exemplary screen view of an application search results list in accordance with an embodiment of the present disclosure.

FIG. 18 depicts an exemplary screen view of an application recommendations list in accordance with an embodiment of the present disclosure

FIG. 19 depicts an exemplary screen view of an application search results list in accordance with an embodiment of the present disclosure.

FIG. 20 depicts an exemplary screen view of an application search results list in accordance with an embodiment of the present disclosure.

FIG. 21 depicts an exemplary screen view of an application launch page in accordance with an embodiment of the present disclosure.

FIG. 22 depicts a flowchart of an exemplary process in which an application search engine provides applications for display with application search results, in accordance with an embodiment of the present disclosure.

FIG. 23 depicts a flowchart of an exemplary process in which an application search engine establishes subscription plans allowing users to access applications, in accordance with an embodiment of the present disclosure.

FIG. 24 depicts a general computer architecture on which the present embodiments can be implemented and has a functional block diagram illustration of a computer hardware platform which includes user interface elements.

### DETAILED DESCRIPTION

In the following detailed description, numerous specific details are set forth by way of example in order to provide a thorough understanding of the relevant embodiments described herein. However, it should be apparent to those skilled in the art that the present embodiments may be practiced without such details. In other instances, well known methods, procedures, components and/or circuitry have been described at a relatively high-level, without detail, in order to avoid unnecessarily obscuring aspects of the embodiments described herein.

The present disclosure relates to methods, systems and programming for providing adaptive application searching and application recommendations. The embodiments described herein describes an application search engine that leverages information associated with a user and information associated with applications to provide highly relevant application search results and recommendations. The application search engine facilitates search results displayable by both personal computing devices, as well as handheld or mobile devices. When a user searches for applications using the application search engine, search results are returned in a filtered fashion such that the search results will display only the applications for a specific device the user is using or specified by the user, and using information associated with a user such as information from a user profile. Thus, the search results will be targeted to the user. Additionally, information regarding a particular user's application usage can be gathered. Using this information in conjunction with other information associated with the user, application recommendations may be furnished automatically or at the user's request.

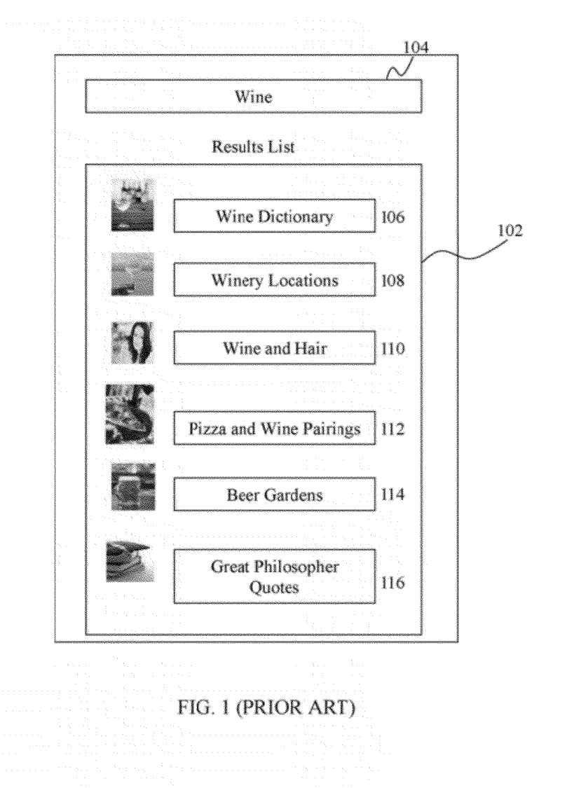

FIG. 1 depicts an exemplary prior art system application search result list. Search result list 102 corresponds to an entry in search query 104. Search query 104, for example, shows “wine” as the entered query. Search result list 102 shows a list of applications corresponding to the search query “wine,” While the first two results 106 and 108, representing applications titled “Wine Dictionary” and “Winery Locations” is relevant to the search query, the next result 110, “Wine and Hair” is questionable. Search result 112 again returns to relevancy with a result for a “Pizza and Wine Pairings” application. However, the search results once again move from less relevant to irrelevant as search result 114 is for “Beer Gardens,” not related to wine, and search result 116 is for “Great Philosopher Quotes” which is completely unrelated. Thus, from search result list 102, it can be seen that application search results are not reliable, produce irrelevant results, and most importantly are not tailored to the user. For example, if a user were located in California and used this search query for “wine,” there is no personalization of the results based on the user's location. Additionally, the user may be searching specifically for applications related to vintage wines, but the search engine has no way of knowing this, thus requiring the user to go through the time consuming task of mining through the search result list to find what is needed.

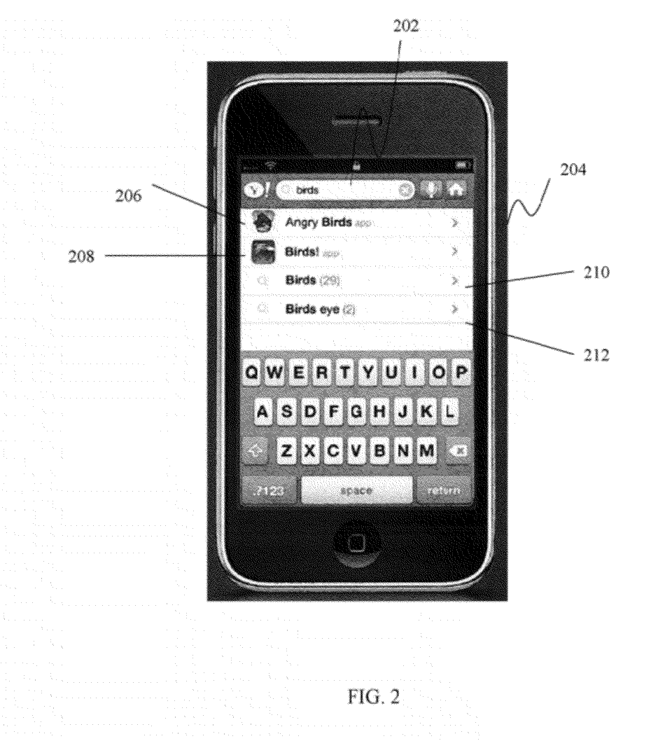

FIG. 2 depicts an exemplary application search result list in accordance with an embodiment of the present disclosure. FIG. 2 depicts a search result list provided by an application search engine, as described in accordance with an embodiment of the present disclosure. In FIG. 2, search query 202 shows an entry “birds,” Instead of producing a straight (and oftentimes confusing) list of results, search result list 204 displays results by first displaying the two most popular or viewed results, 206 and 208. After these results, result categories 210 and 212 are shown. Results 206 and 208, represent two applications that have been identified as most relevant to the search query entry “birds” based upon an analysis of information including trending data, user data, and other relevant data. A more detailed explanation of the analysis of information is given in the paragraphs shown below. Result categories 210 and 212, when selected, will display lists of applications related to those categories. Thus, search results list 204 provides a user with a list that is tailored to the search query by first displaying recommended applications based on analysis of information, and further in the list displaying categories for selection to receive search results in a traditional listed manner.

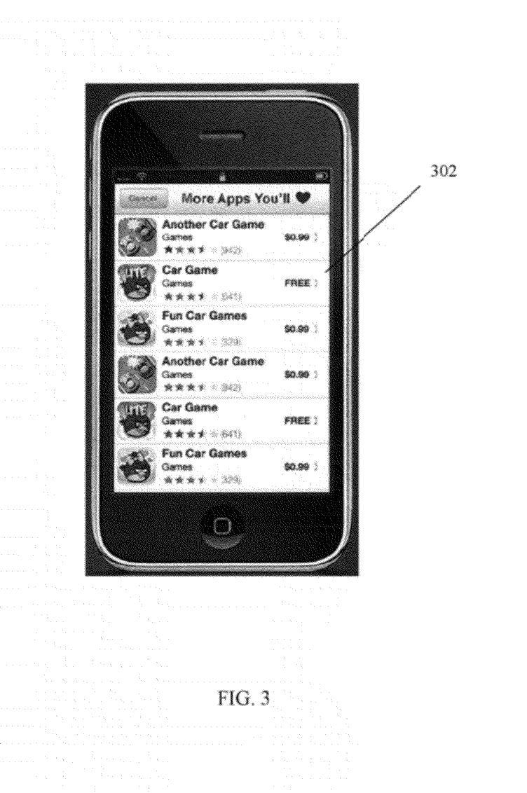

FIG. 3 depicts an exemplary application recommendation list in accordance with an embodiment of the present disclosure. When an application search engine provides a search result list to a device or a user, in accordance with an embodiment of the present disclosure, the user may be presented with an option to view a list of recommended applications. The list of recommended applications, such as those shown in list 302 is presented on the basis of an analysis of the aforementioned information, including trending data, user data, and other relevant data that is described in greater detail in the paragraphs below.

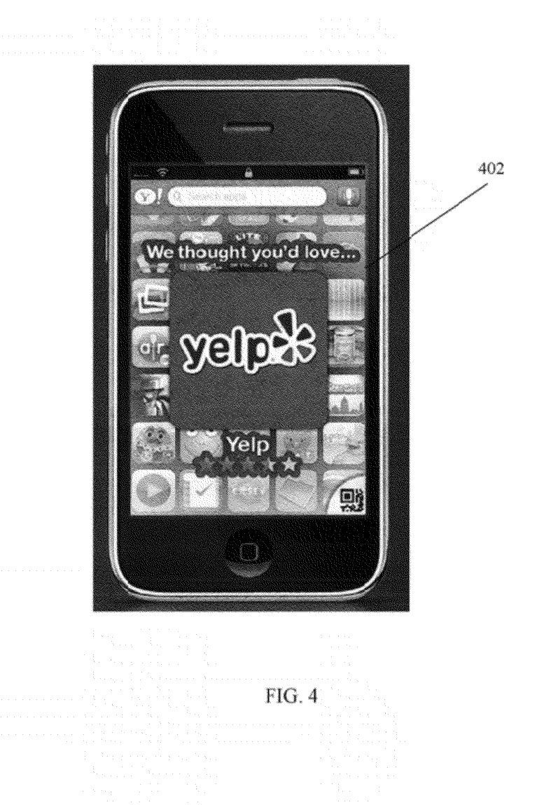

FIG. 4 depicts an exemplary application recommendation in accordance with an embodiment of the present disclosure. The application search engine may also recommend a single application for the user of the device that the user may not be aware of. This is shown in screen 402 with a recommendation for the user to download the application shown. This recommendation is also made based upon an analysis of the aforementioned information, including trending data, user data, and other relevant data. For example, a user may have a profile indicating that he/she is interested in reviews of people, places, and restaurants. The user may also already have many applications installed on the device which relate to food. The application search engine may obtain this information and leverage it in order to provide the recommendation shown in screen 402 to the user.

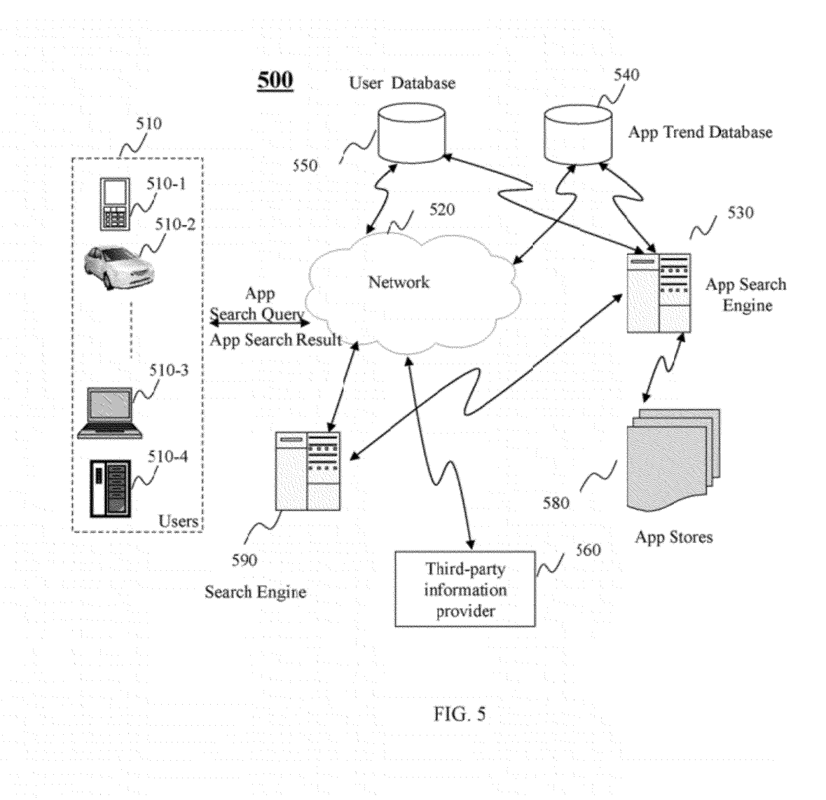

FIG. 5 is a high level depiction of an exemplary system 500 providing mobile application search results and recommendations, in accordance with an embodiment of the present disclosure. Exemplary system 500 includes users 510, network 520, application search engine 530, application trend database 540, user database 550, third-party information provider 560, application stores 580, and search engine 590. Network 520 can be a single network or a combination of different networks. For example, a network may be a local area network (LAN), a wide area network (WAN), a public network, a private network, a proprietary network, a Public Telephone Switched Network (PTSN), the Internet, a wireless network, a virtual network, or any combination thereof. A network may also include various network access points, e.g., wired or wireless access points such as base stations or Internet exchange points, through which a data source may connect to in order to transmit information via the network.

Users 510 may be of different types such as users connected to the network via desktop connections (510-4), users connecting to the network via wireless connections such as through a laptop (510-3), a handheld device (510-1), or a built-in device in a motor vehicle (510-2). A user may submit an application search query through network 520. The application search query may be directed to application search engine 530, which provides an application search result back to the user. The application search result provided to the user may be based upon information received from the user, information stored at user database 550 and application trend database 540, third-party information provider 560, and application stores 580. Once a user has access to a search engine provided by application search engine 530, the user may send instructions or requests to search engine 590 and/or application search engine 530 via network 520. Application search engine 530, may in turn produce application search results for display by the user.

For example, one of users 510 submits an application search query to application search engine 530, The search query may be routed to application search engine 530 via search engine 590. Once application search engine 530 receives the application search query, application search engine 530 obtains as much information about the user, the user's device, and available applications from users 510, user database 550, application trend database 540, app stores 580, and third-party information provider 560 to provide filtered and directed search results that are personalized for the user. By using the information obtained, application search engine 530 may also determine application recommendations that may be sent to the user. Application search engine 530 may also store statistics related to the download and purchase of applications by users 510 in order to compile statistics that may be used to respond to future application search queries or provide application recommendations. Third-party information providers 560 may also leverage the information gathered by directing application search engine 530 to produce for display pages to users 510 to download certain applications. Third-party information providers 560 may also leverage the information to direct application search engine 530 to provide users 510 with targeted advertisements for display with application search results, and application recommendations.

Application trend database 540 includes data associated with applications that are trending. Applications that are classified as trending may be applications that may have been viewed or downloaded at a greater rate. Applications may also be classified as trending based on high user reviews for the applications, a user's location, social networking data, and a user's personal relationships (for example, if many of a user's friends in a social network have downloaded or viewed the application.) Trending applications may be defined as applications that have grown in popularity in a short time period. Application trend database 540 may provide this data to application search engine 530 to assist application search engine 530 in determining which applications to list on a search result list in response to an application search query. Application search engine 530 may also use this data to determine which applications to recommend to a user. Third-party information provider 560 may use this data to determine which applications to sponsor or which applications to place advertisements next to during display of the applications in an application search result list.

User database 550 includes data associated with users of a device at which application search queries are entered. This data may include information related to the users device, such as certain characteristics of the device relating to video and audio capabilities, profile information of the user including information about a user's application preferences and hobbies and interests, and information relating to current applications installed on the user's device and the user's usage of these applications. The data in the user database 550 may also include lists of personal contacts, social networking groups, and social networking websites that a user is a part of. All of this information may be used in conjunction with information in application trend database 540 to allow application search engine 530 to determine which applications to list on a search result list in response to an application search query. Application search engine 530 may also use this data to determine which applications to recommend to a user. Third-party information provider 560 may use this data to determine which applications to sponsor or which applications to place advertisements next to during display of the applications in an application search result list.

Third-party information provider 560 may represent a sponsor or an advertiser who wishes to associate their product or services with an application that is listed in an application search result list or application recommendation. Third-party information provider 560, for example, may direct application search engine 530 to present an advertisement alongside any application search result list that displays search results for a search query for “animals.” Additionally, a third-party information provider 560 may sponsor certain applications, which may appear under certain conditions while a user of a device is browsing an application search result list or application recommendation list provided by application search engine 530.

Application stores 580 represent application stores such as iTunes and Android Marketplace which server applications to user devices. Application search engine 530 searches through applications that reside within application stores 580, extracts relevant information about the applications, and analyzes that information in conjunction with any information obtained from the users, user database 550, application trend database 540, and third-party information provider 560 in order to determine an application search result list to provide to a user in response to a user's application search query. Application search engine 530 may also periodically poll application stores 580 for information that may be stored in application trend database 540, such as information regarding ratings of an application or number of downloads of an application.

In an embodiment, the user 510-1 using a mobile device sends an application search query through network 520. The application search query is routed to application search engine 530. Application search engine 530 then obtains information relating to the user and information relating to applications. This information is obtained from both user database 550 and application trend database 540. Application search engine 530 then analyzes the application search request, and determines a list of applications based on the analysis. This list of applications may be provided to user 510-1 from application search engine 530 via network 520 in the form of an application search result list. This application search result list may be formatted to be viewable by a device used by user 510-1.

In another embodiment, based on user settings, certain applications may be automatically installed on a device. For example, user 510-1 may have specified that all applications related to personal finance be automatically installed. Thus, when user 510-1 searches for applications related to personal finance, these applications may be installed automatically once the application search result list is provided.

In another embodiment, application search engine 530 analyzes data from user 510-1, user database 550, and application trend database 540. Based on this analyzed data, application search engine 530 may associate certain advertisements as directed by third-party information provider 560 to specific applications. Thus, when user 510-1 views an application search result list with the applications in the list, the advertisements will also be displayed. Similarly, the advertisements may be associated with the applications to cause the advertisements to display when an application launch page is reached. An application launch page may be reached, for example, when a user 510-1 selects an application from an application search result list to see more information or possibly download the application.

In another embodiment, application search engine 530 may obtain information related to a download of an application by a user 510-1. For example, if user 510-1 downloads an application related to cars, application search engine 530 may receive data representing statistics of user 510-1's usage of the application. Application search engine 530 may update a record based on the download of the application and receive a payment from, for example, the application developer based on the download. Application search engine 530 may also use the statistics to improve application search results provided to user 510-1 and provide improved application recommendations.

In another embodiment, application search engine 530 may obtain information from user database 550 and application trend database 540 in order to analyze the information to assist in establishing a subscription plan according to certain predetermined terms set by either a user and/or application search engine 530. The subscription plan provides a user access to certain applications on the basis of the information which allows the access to applications to be tailored around a user's specific interests.

In another embodiment, and especially in the event that the user is using a mobile or handheld device, such as user 510-1, application search engine 530 provides an application search application to the device of user 510-1. The application search application allows user 510-1 to enter application search queries and solicit application search results from application search engine 530. Likewise, the application also allows application search engine 530 to serve application recommendations, advertisements, sponsored applications, and subscription plan applications to user 510-1, as described above.

In another embodiment, application search engine 530 receives application search queries and application search results through a web browser viewable by the devices of users 510. Additionally, the web browser may also facilitate communication of application recommendations, advertisements, sponsored applications, and subscription plan applications to user 510-1, as described above,

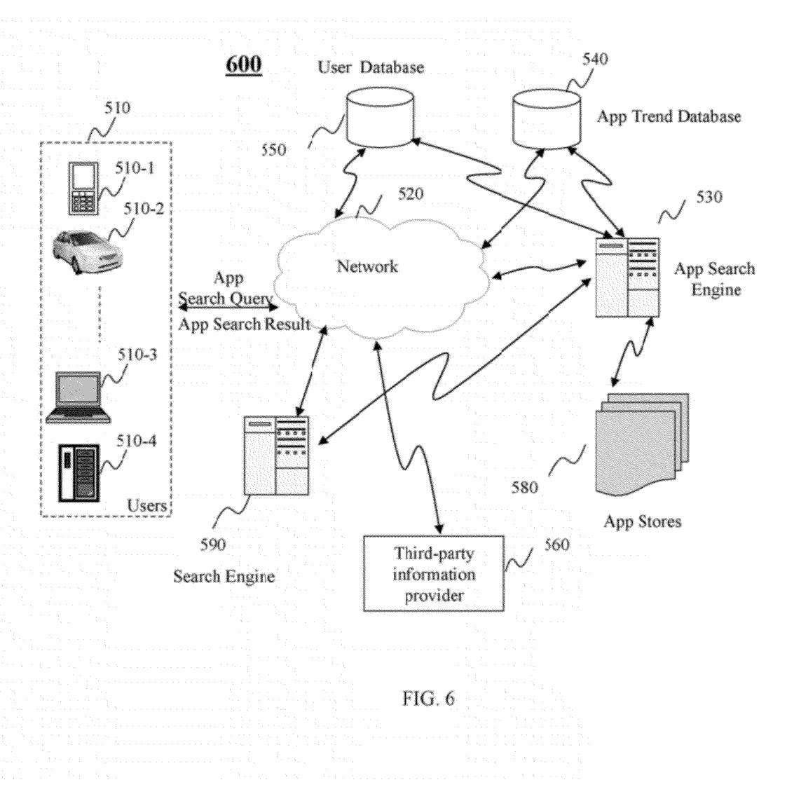

FIG. 6 is a high level depiction of an exemplary system 600 providing mobile application search results and recommendations, in accordance with an embodiment of the present disclosure. In this embodiment, application search engine 530 may directly communicate with all other components through network 520. Thus, application search queries do not need to be routed through search engine 590 to reach application search engine 530, and likewise, application search engine 530 can communicate directly with users 510 to provide application search results, application recommendations, advertisements, and other information described above.

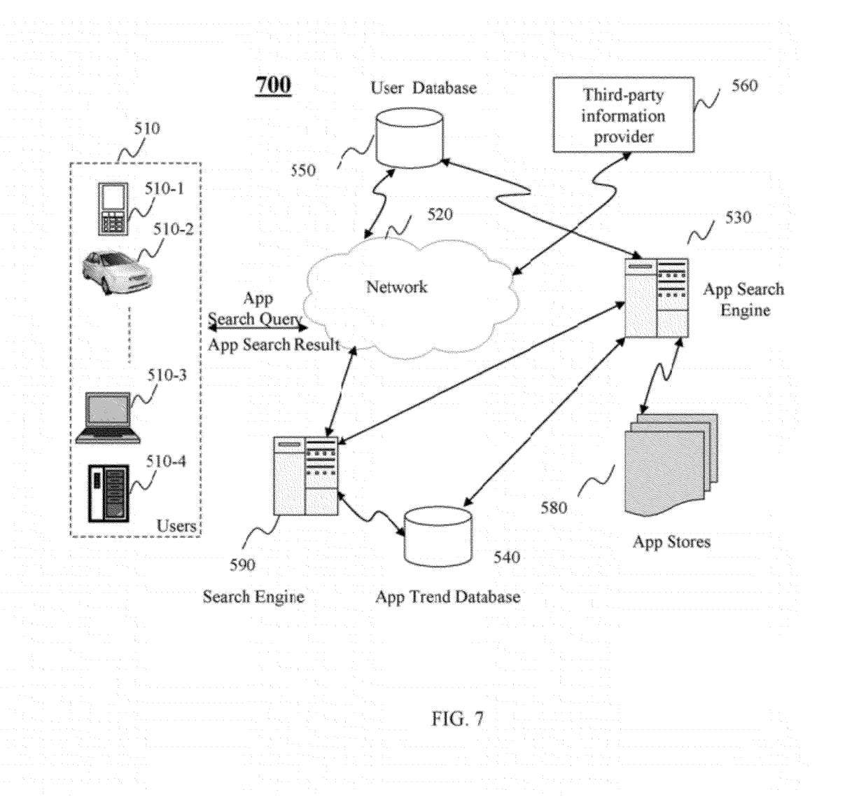

FIG. 7 is a high level depiction of an exemplary system 700 providing mobile application search results and recommendations, in accordance with an embodiment of the present disclosure. In this embodiment, application trend database 540 is configured to communicate only with search engine 590 and application search engine 530. In this embodiment, information in application trending database 540 may be kept private from users 510 and third-party information provider 560.

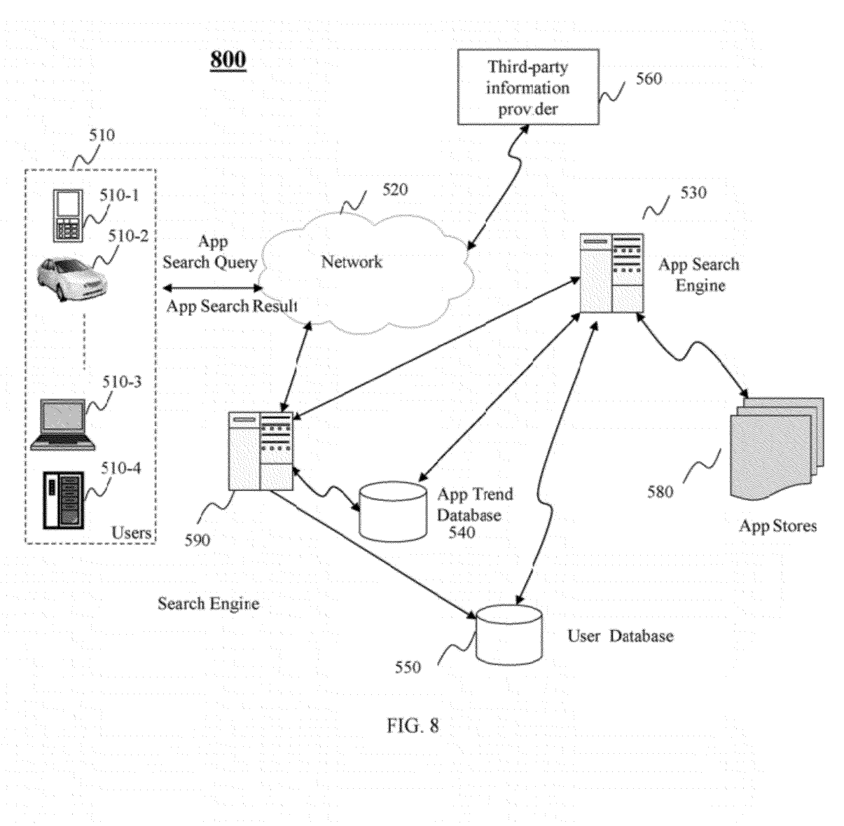

FIG. 8 is a high level depiction of an exemplary system 800 providing mobile application search results and recommendations, in accordance with an embodiment of the present disclosure. In this embodiment, all application search queries are directed to application search engine 530 via search engine 590 via network 502. Likewise, all application search results, application recommendations, advertisements, and applications are delivered via search engine 590 to network 502 to users 510. Additionally, both user database 550 and application trend database 540 are accessible only to application search engine 530 and search engine 590 This embodiment may be used when user 510 uses a web browser to enter application search queries and receive application search results, application recommendations, and advertisements.

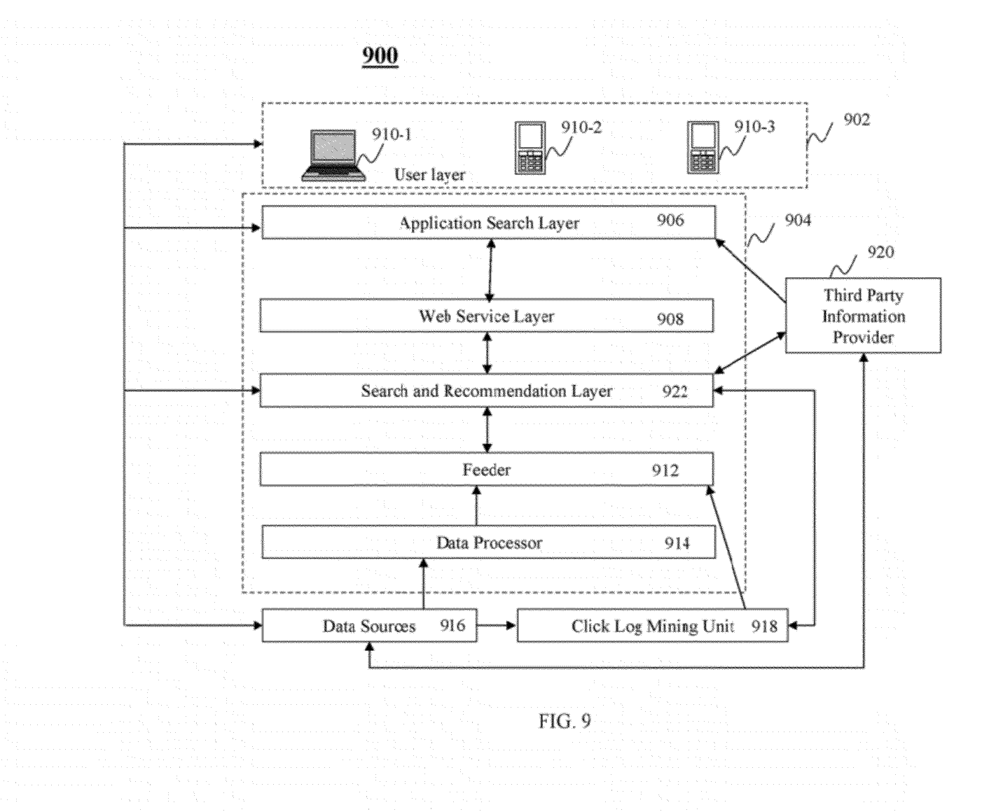

FIG. 9 is a high level depiction of an exemplary system 900 showing the interaction between users, an application search engine, data sources, and third-party information provider, in accordance with an embodiment of the present disclosure. User layer 902 represents devices 910-1, 910-2, and 910-3 that may be used by users to access application search engine 904 as shown in FIG. 9. Devices 910-1, 910-2, and 910-3 may transmit application search queries to application search engine 904 either via a web browser or an application searching application. For example, if device 910-1 represented a desktop computing device, it would be simpler and more efficient for a user of device 910-1 to submit application search queries and view application search results through a web browser rather than requiring a stand-alone application that may need to be executed separately.

In another example, if device 910-2 represented a mobile smartphone, using a dedicated application searching application may be more efficient and thus device 910-2 may utilize an application searching application to submit application search queries and receive application search results from application search engine 904.

Application search engine 904 includes application search layer 906, web service layer 908, search and recommendation layer 922, feeder 912, and data processor 914. Also part of system 900 are data sources 916, click log mining unit 918, and third party information provider 920.

Data sources 916 may be repositories of user information and application information. For example, data sources 916 may include user database 550 and application trend database 540. As described above, user database 550 stores information related to profiles of users describing user interests and application usage, and application trend database 540 stores information related to which applications are currently trending. Click log mining unit 918 logs application views in a particular application store and provides this data to a data source such as application trend database 540. Application trend database may then store this data in conjunction with other information received and stored by application trend database so that it may be used by application search engine 904 to determine trending applications.

Information and data from data sources may be transmitted to application search engine 904 through data processor 914 which processes the received data and information to prepare the data and information for usage by application search engine 904. The processed data and information may then be submitted to a feeder 912, which simultaneously may receive data from click log mining unit 918, and feed this data to search and recommendation layer 922 for analysis.

Search and recommendation layer 922 of application search engine 904 receives search results from users in user layer 902. For example, a user represented by user layer 902 may transmit an application search query to application search engine 904 to search for a particular type of application based on a keyword or search term. This application search query is directed to search and recommendation layer 922 which analyzes the application search query in conjunction with information and data received from feeder 912. Based on the analysis, search and recommendation layer 922 can generate an application search result list either listing all applicable applications or filtered base upon the user's device. Search and recommendation layer 922 may also determine related categories based on the application search query and provide specific application recommendations based on data such as past application usage of a user, interests of a user obtained from a user profile, geographic location of the user device, time data of the user device, and social networking information related to the user's social network, such as information regarding interests and applications used by those connected to the user via the user's social network. Search and recommendation layer 922 may also leverage information related to the user's device capabilities, such as processing power requirements, memory requirements, power consumption requirements, and bandwidth requirements for applications. Thus, if certain applications do not match the user device's capabilities, these applications may be filtered from the application search result list and not be included.

Search and recommendation layer 922 may also take into account information received from third party information provider 920 For example, if third party information provider 920 is a sponsor or advertiser associated with a particular application, these applications may be ranked higher on an application search result list. Furthermore, these applications may be flagged and provided as application recommendations. Third party information provider 920 may also be a partner, which can request certain applications be excluded from search results based on characteristics of the user's device. For example, if a user's smartphone 910-2 is registered on the Sprint network and third party information provider 920 is a different network operator such as T-Mobile, third party information provider 920 can instruct search and recommendation layer to exclude from the search results certain applications which have been tagged as exclusive to T-Mobile customers, and thus a user of smartphone 910-2 would not see those applications on an application search result list. If third party information provider 920 were an advertiser, the advertiser may specify that a particular advertisement be associated with a certain application such that the advertisement is provided for display at a user device whenever the corresponding application appears on an application search result list or appears as an application recommendation

Web service layer 908 serves as an intermediary layer between application search layer 906 and search and recommendation layer 922. Whereas search and recommendation layer 922 is responsible for receiving application search queries and providing responses to application search queries in the form of application search result lists, application recommendations, advertisements, and other information, application search layer 906 is responsible for the processing data and information received from search and recommendation layer 922 for display by any user device such as devices within user layer 902. As a result, web service layer 908 facilitates communication between application search layer 906 and search and recommendation layer 922 to ensure that results can be delivered appropriately depending on the type of device being used by a user in, for example, user layer 902.

Application search layer 906 receives application search result lists and application recommendations from web service layer 908. Application search layer then provides the application search result lists and application recommendations for display on any variety of devices such as devices 910-1, 910-2, and 910-3 of user layer 902. Application search layer 906, for example, may provide device 910-1, a desktop computing device, with a website viewable through a web browser in order for a user of device 910-1 to submit an application search query. Once results are compiled and received at application search layer 906, application search later 906 provides the results in a suitable form for display based upon information from search and recommendation layer 922. For example, results may be displayed in a certain order based on any of the information analyzed by search and recommendation layer 922. If a current location of device 910-1 is Florida, USA, then depending on what the application search query is, higher ranked results in the application search result list may refer to applications pertaining to local Florida businesses.

In an alternate embodiment, application search layer 906 may provide a mobile handheld device, such as device 910-2, an application search result list formatted for an application search application executing on device 910-2. As such, the initial application search query would also be received by application search engine 904 from device 910-2 through the application search application.

Application search layer 906 may also furnish recommendations determined by search and recommendation layer 922 for display on a device. These recommendations may be formatted to highlight certain sponsored applications or based upon any of the data and information processed by search and recommendation layer 922. Application search layer 906 may further receive information from third-party information provider, such as advertisements that are associated with certain applications. These advertisements may be conveniently displayed next to an associated application within an application search result list.

Application search engine 904 as depicted in FIG. 9, application search engine 530, and any other application search engine referred to herein, thus provides superior search relevancy, recommendation of applications, and is platform agnostic by providing a web based option for searching applications. Additionally, user profiling, by continuous collection of information about users and user devices provides useful information for ensuring that application search result lists and application recommendations are specifically tailored based on a particular user's application usage track record and preferences. Application recommendations may also be deployed automatically to user devices, especially in the case of location based triggers. For example, if a user is in a large shopping center, application search engine 904 may provide an automatic application recommendation of a maps application that includes a map of the shopping center. In another example, if a user is at a movie theater, an automatic application recommendation of an application showing movie times and trailers may be provided.

Application recommendations may be provided for display in a carousel style view where each recommended application may be actionable to reach an application launch page. The carousel style view may also be sideswiped to navigate through a list of application recommendations.

Additionally, if a user owns more than one device, which is often the case, application search engine 904, through instructions from user devices, may be configured to synchronize installed applications on all devices, even if the devices use different platforms or operating systems.

An application search engine, as described herein may deliver an application searching application to user devices where the devices are mobile handheld devices. The application searching application allows a user to submit application search queries and provides presentation of results in the form of application search result lists, application recommendations, and advertisements. The application searching application may also provide additional services such as automatic download of certain applications based on a user profile, such as those that are part of a subscription plan. The application searching application may advantageously provide application recommendations based on individual user based interests with regard to other applications or with regard to general interests, direct application search results in real-time as a user types in a search query field, the ability to easily navigate to similar applications, and search results that may be grouped in categories.

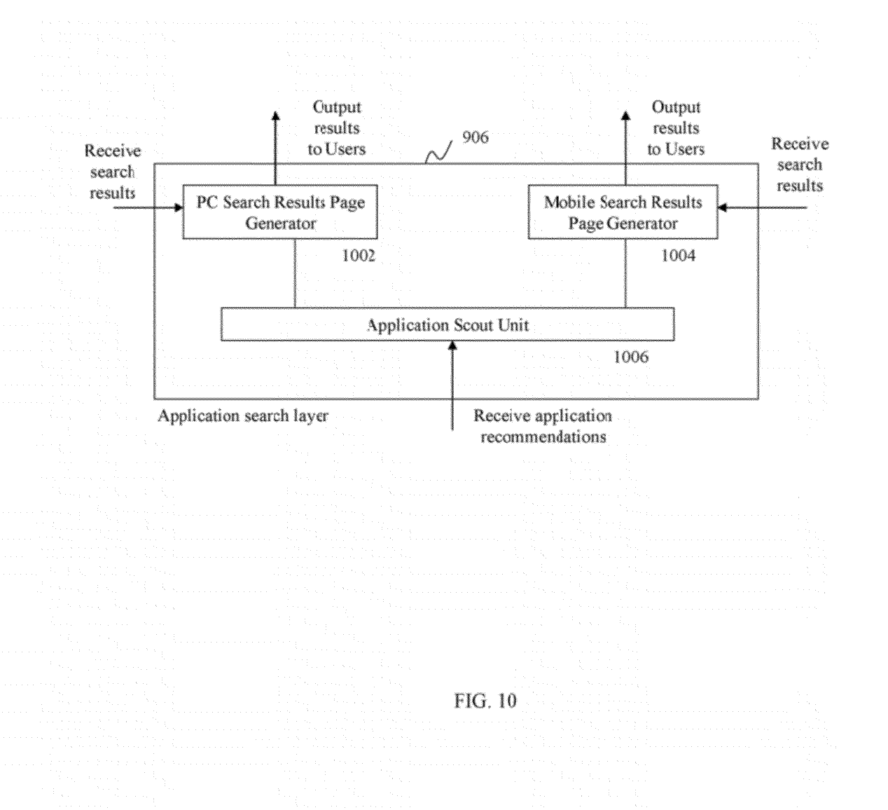

FIG. 10 is a high level depiction of an exemplary application search layer, in accordance with an embodiment of the present disclosure. Application search layer 906 is depicted by FIG. 10. Application search layer 906 includes PC Search Results Page Generator 1002, Mobile Search Results Page Generator 1004, and Application Scout Unit 1006. PC Search Results Page Generator 1002 receives application search results from, for example, search and recommendation layer 922. PC Search Results Page Generator 1002 processes the application search results for viewing from a PC or any type of desktop computing device or general computing device. PC Search Results Page Generator may provide a web browser viewable page showing application search results. Mobile Search Results Page Generator 1004 receives application search results, from, for example, search and recommendation layer 922. Mobile Search Results Page Generator 1004 processes the application search results for viewing from a mobile handheld device, such as a smartphone or tablet. Mobile Search Results Page Generator 1004 provides a page including application search results that may be displayed in an application searching application installed on a user's device.

Application Scout Unit 1006 receives application recommendations from application search layer 906. Application Scout Unit 1006 processes the application recommendations and provides them to either PC Search Results Page Generator 1002 and Mobile Search Results Page Generator 1004 so that the application recommendations may be displayed either alone or in conjunction with application search results. Application Scout Unit 1006 may also passively, without user input, analyze application recommendations, and select ones that may be most appropriate to deliver to a user device for display based on a information about the user and information about applications such as trending application data. Application Scout Unit 1006 may for example facilitate delivery of an application recommendation or list of application recommendations at predetermined time periods.

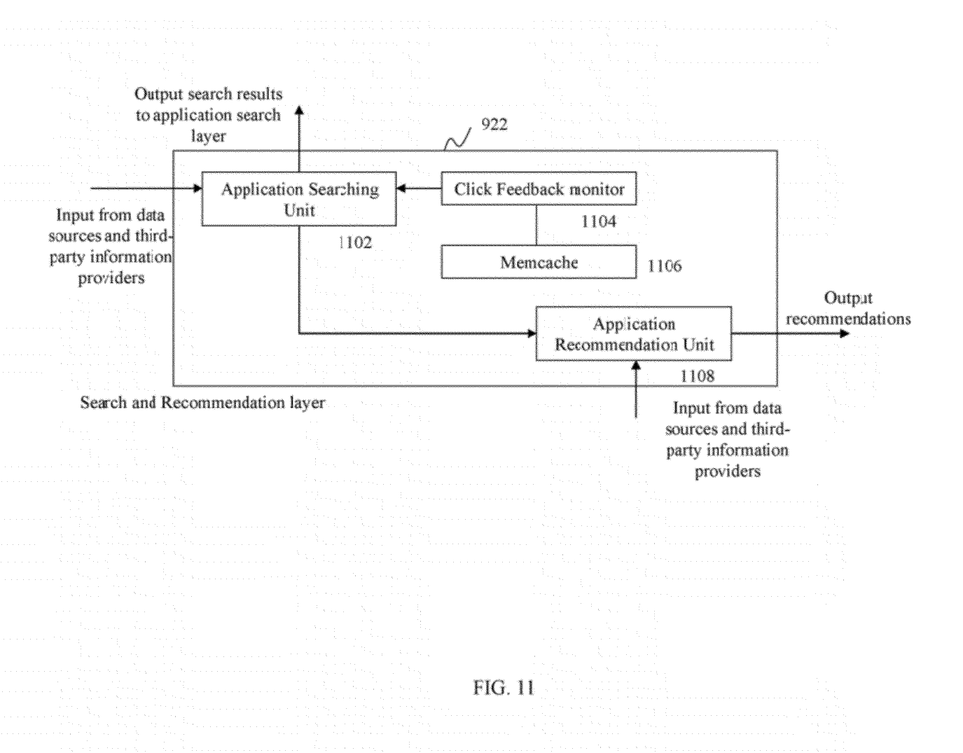

FIG. 11 is a high level depiction of an exemplary search and recommendation layer, in accordance with an embodiment of the present disclosure. Search and recommendation layer 922 is depicted by FIG. 11. Search and recommendation layer 922 includes application searching unit 1102, click feedback monitor 1104, memcache 1106, and application recommendation unit 1108. Application searching unit 1102 is responsible for responding to application search queries. When there is an application search query received by application search engine 530, application searching unit may receive input from data sources representing information about users of devices that submit application search queries and also information about applications such as trending application data. Application searching unit 1102 analyzes the information from the data sources in light of application search queries, and prepares application search result lists that are transmitted to application search layer 906 for presentation to users at their devices. Application searching unit 1102 may also receive information from click feedback monitor 1104. Click feedback monitor 1104 monitors clicks or usage of various applications. The information from click feedback monitor 1104 can be used by application searching unit 1102 to refine search results in an attempt to provide relevant results to users. Memcache 1106 is a dynamic memory caching unit that facilitates faster database searching by caching data. Thus, memcache 1106 improves performance and efficiency of search and recommendation layer 922. Application recommendation unit 1108 is responsible for serving application recommendations as well as assisting application searching unit 1102 with provision of search results. Application recommendation unit 1108 uses input from data sources and/or third-party providers, similarly to application searching unit 1102, and analyzes this information to determine which applications to recommend to users based on user preferences, current and past application usage, and application trending data Recommendations are output by application recommendation unit 1108 to application search layer 906 for presentation to users at their devices

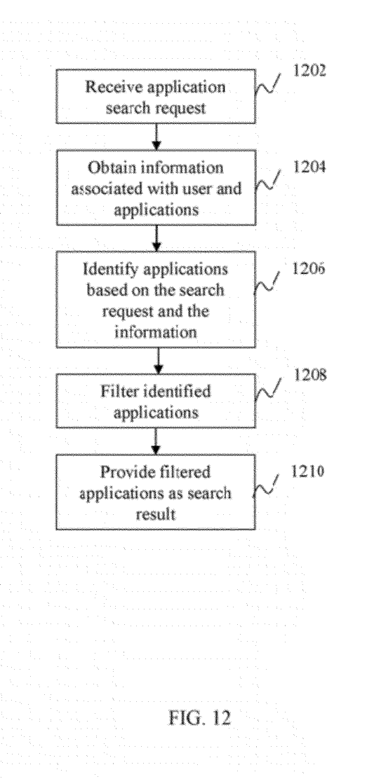

FIG. 12 depicts a flowchart of an exemplary process in which an application search engine provides application search results to devices, in accordance with an embodiment of the present disclosure. At 1202, application search engine 530 receives an application search request or query. This application search request or query may be a keyword explaining a type of application a user is interested in or a keyword of a word that may be a part of an application title or description that a user is interested in. For example, a user looking for games involving birds may type the keyword “Birds” which is sent to application search engine 530 by a users 510 through their devices.

At 1204, after application search engine 530 has received an application search request, application search engine 530 obtains information associated with the user sending the application search request and information about various applications that are available from application stores. Information may be obtained directly from a user or user device, such as capabilities of the device, operating system information, and user preferences. Information may also be obtained from user database 550 which may store user device information, profiles of users including user preferences and past behavior of users with regard to applications, user location data, and social networking information related to the users. Application trend database 540 may also provide information to application search engine 530. Application trend database 540 provides application trending information related to which applications are currently trending/or popular. Further information may also be obtained about specific applications from application stores 580.

At 1206, application search engine 530 identifies applications based on the application search request and the information obtained during step 1204. These identified applications are specifically tailored based on the information in order to provide a list of application search results that is relevant to the user originally submitting the application search request or query.

At 1208, the identified applications may be filtered. Filtering the applications may be performed based on certain criteria such as removing certain applications which may no longer be available for download, or removing applications that do not meet a certain price threshold set by a user of a device. The filtering may also be performed based upon other application characteristics such as statistics associated with the identified applications.

At 1210, the filtered applications are provided as a list of search results. This application search result list may then be formatted and provided to a user's device so that a user can view and browse the application search result list. Selection of any of the applications on the application search result list by a user results in the user being brought to an application launch page associated with that application.

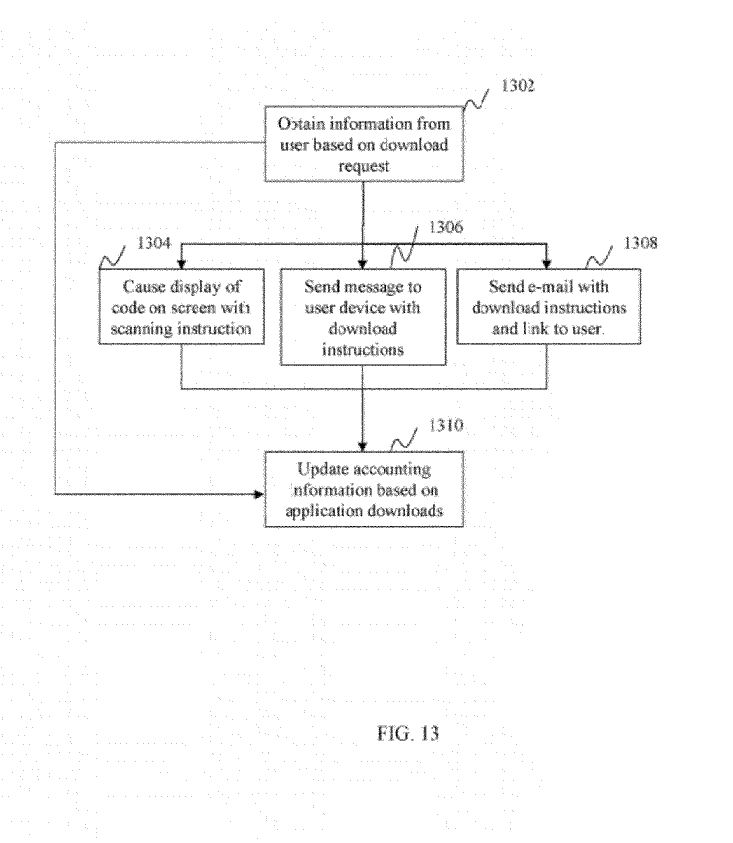

FIG. 13 depicts a flowchart of an exemplary process in which how an application search engine handles download of applications based on the application search result list, in accordance with an embodiment of the present disclosure. When a user of a device selects an application from an application search result list for download, at 1302, application search engine 530 obtains information from the user based on receiving a download request. Application search engine 530 may keep a record of the application requested for download, such as the type of application, time of request from the user, and any other relevant information which may be used and stored in user database 550 or application trending database 540 to assist with future application search requests or queries. The process then proceeds differently depending on what device a user has used to request download of an application.

If the application search result list was viewed from a device, such as a personal computing device using a web browser, then the process may continue by proceeding to any of steps 1304, 1306, or 1308. If the application search result list was viewed from a mobile handheld device using an application searching application, then the process continues to step 1310. At 1304, in response to receiving a request to download an application, application search engine 530 may cause display of a code on a screen of the personal computing device including scanning instructions. For example, the code may be a OR code that is scannable from a user's mobile handheld device which the application is intended for. Thus, the user may use their handheld device to scan the code on the screen of the personal computing device, the scanning of the code bringing the handheld device automatically to a display allowing download of the application to the mobile handheld device.

At 1306, in response to receiving a request to download an application, application search engine 530 may send a message to a user's mobile handheld device with download instructions. For example, the user of the personal computing device may receive a prompt to enter information about their mobile handheld device, such as a telephone number. Application search engine 530 may then transmit a message using a messaging protocol, such as SMS, MMS, or any other known communication protocol to the mobile handheld device associated with the telephone number with detailed instructions on how to download the application for the mobile handheld device.

At step 1308, in response to receiving a request to download an application, application search engine 530 may send an e-mail with download instructions and a link to the user at a user's mobile handheld device. For example, the user of personal computing device may receive a prompt to enter an e-mail address for the e-mail to be sent to. The user may then view the e-mail from their mobile handheld device and activate the link which provides a display allowing download of the application to the mobile handheld device.

The process then proceeds to 1310, where application search engine 530 updates accounting information based on the download of the application. The accounting information update includes updating a record that the user has downloaded the application to ensure that a developer or associated third-party is paid.

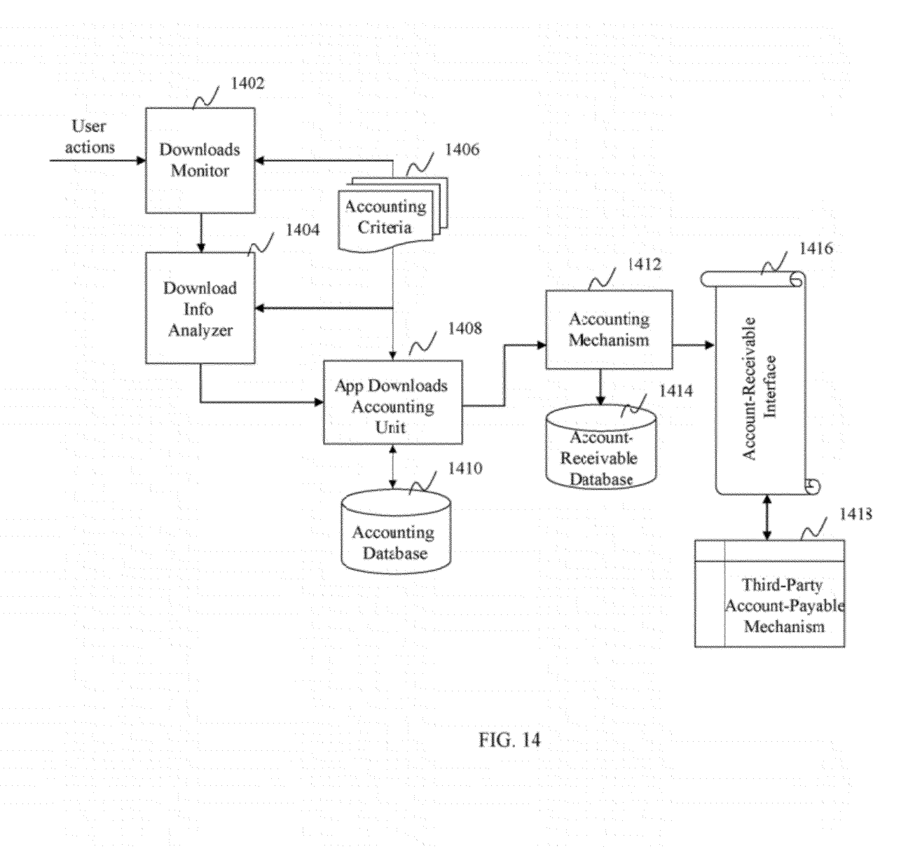

FIG. 14 depicts an exemplary high level diagram of a system facilitating accounting associated with the download of applications, in accordance with an embodiment of the present disclosure. System 1400 shown by FIG. 14 depicts downloads monitor 1402, download information analyzer 1404, accounting criteria 1406, application downloads accounting unit 1408, accounting database 1410, accounting mechanism 1412, and account-receivable database 1414, which may, in an embodiment, be a part of application search engine 530. Accounting mechanism 1412 may provide an account-receivable interface 1416 which is accessible by third-party account-payable mechanism 1418. Downloads monitor 1402 is responsible for keeping track of and monitoring which applications are downloaded, by which users, and how many times each application is downloaded. Downloads monitor 1402 may also continuously monitor application usage of an application after a user has downloaded the application to their device. This information may be sent to download information analyzer 1404 which analyzes all of the information collected by downloads monitor 402 in order to send this information to an accounting unit such as application downloads accounting unit 1408. Accounting criterion 1406 includes a set of rules associated with accounting, such as pricing information, and information regarding what portion of a payment received for an application should be paid to an application developer, application sponsor, application advertiser, or any other third party.

Application downloads accounting unit 1408 is responsible for receiving information from download information analyzer 1404 and receiving accounting criteria 1406 in order to update accounting database 1410 to update records with regard to application downloads, purchases, payments made, and application usage information. Accounting mechanism 1412 is responsible for updating an account-receivable database 1414 associated with third-party accounts to ensure that payment information associated with applications is furnished to third-party accounts. Account-receivable interface 1416 is provided to a third-party to interface with a third-party account-payable mechanism 1418 to facilitate payment based on download of applications to an appropriate third-party. A third-party may be an application developer, application store, application distributor, application dealer, advertiser, or sponsor.

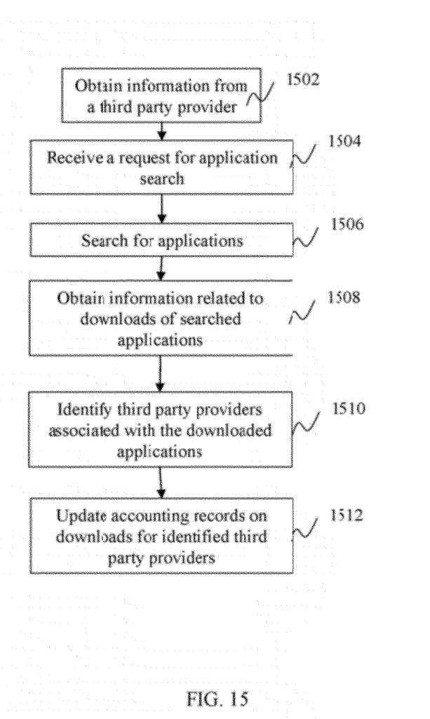

FIG. 15 depicts a flowchart of an exemplary process in which an application search engine updates accounting records for third-party providers based on downloaded applications, in accordance with an embodiment of the present disclosure. At 1502, application search engine 530 obtains information from a third-party provider. This information may be information associating applications with advertisements, for example, or information associating a third-party provider with an application as a sponsor.

At 1504, application search engine 530 may receive a request for application search. This request may be an application search request or application search query discussed above, received from a user of a device either through a web browser interface or through an application searching application. At 1506, application search engine 530 searches for applications based on the application search request, in accordance with the embodiments described above and herein. The results of the search may be furnished to the user of the device in the form of an application search results list, where selection of an application will bring a user to an application launch page where a user may initiate download of the application selected.

At 1508, application search engine 530 obtains information related to any download of applications by the user. This information may be used to determine which third-party providers may receive payments based on the application. For example, if an application that was downloaded had an associated advertisement that was displayed on the application launch page, then the advertiser, a third-party provider, may receive a payment based on the application download.

At 1510, third party providers associated with the searched and downloaded applications are identified. At 1512, accounting records are updated for downloads of applications that are associated with the identified third party providers.

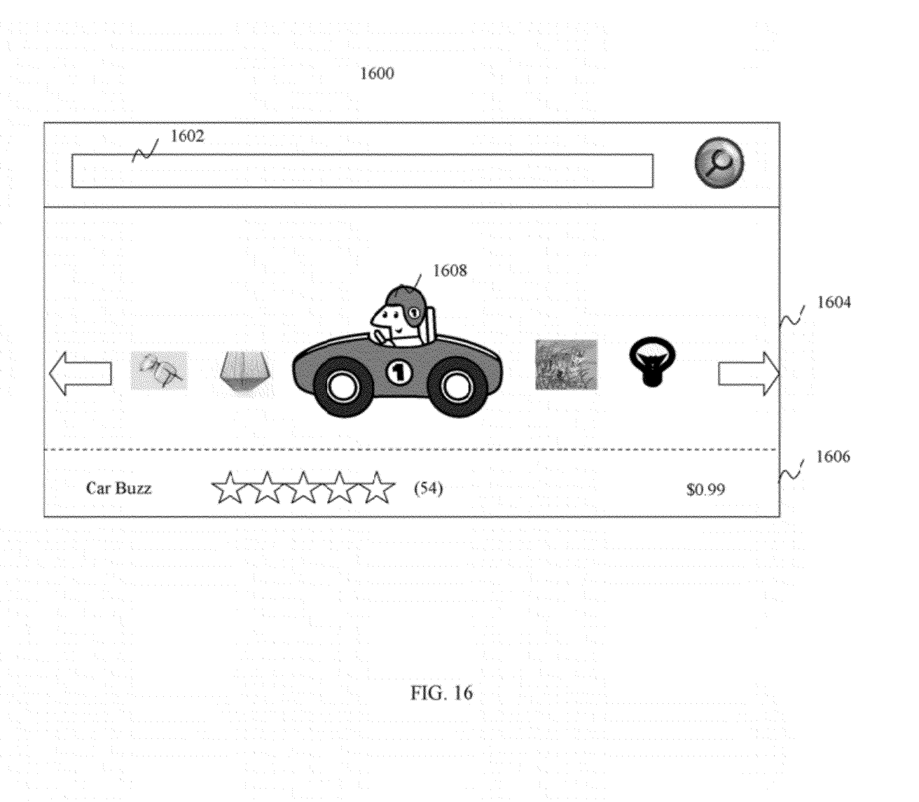

FIG. 16 depicts an exemplary screen view of an application search results list in accordance with an embodiment of the present disclosure. An applications search result list as shown by FIG. 16 is shown as a display that is a part of an exemplary application searching application in accordance with the embodiments described herein. Application searching application 1600 includes an application search query box 1602, application search result list 1604, and application information pane 1606. Application search result list 1604 is displayed as a result of application search engine 530 receiving and processing an application search result from a user device where application searching application 1600 is being executed. Application search result list 1604 is displayed as a carousel list which highlights a currently selected result by displaying a larger image for a selected search result such as search result 1608. Other search results may be selected by horizontally swiping within application search result list 1604. Selection of any of application in the application result list results in the display of an application launch page where a user may access more detailed information about the application and initiate download of the application.

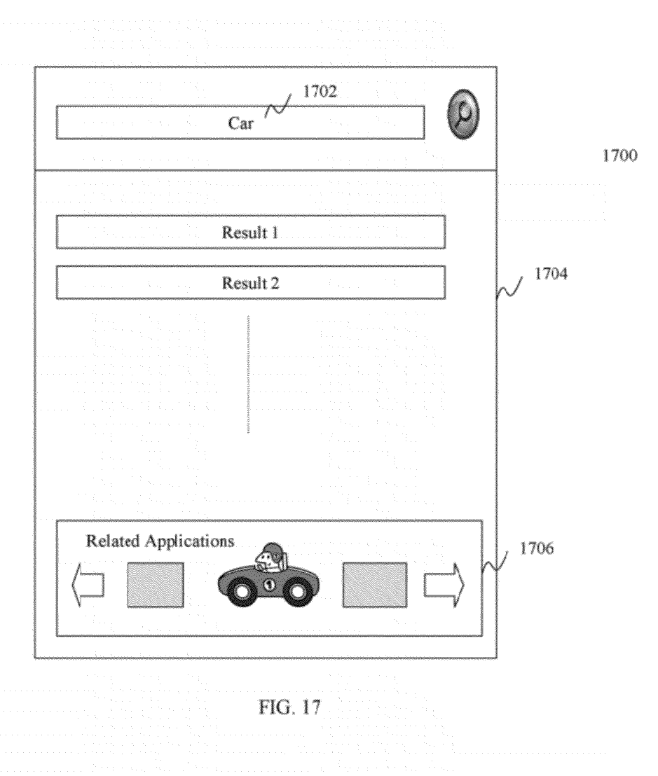

FIG. 17 depicts an exemplary screen view of an application search results list in accordance with an embodiment of the present disclosure. FIG. 17 displays an alternative display of an exemplary application searching application in accordance with the embodiments described herein. Application searching application 1700 includes an application search query box 1702, an application search result list 1704, and a related applications display 1706. Application search query box 1702, for example, includes a query such as “Car” which is entered by a user of a device. Application search result list 1704 is a list of results displayed based on the query in application search query box 1702. Related applications display 1706 displays a carousel list including a list of related recommended applications that may or may not be a part of application search result list 1704. These applications shown in related applications display 1706 may be browsed by horizontal swiping within related applications display 1706. The applications displayed in related applications display 1706 are shown on the basis of application search engine 530 analyzing user information obtained from a user of a device, information from user database 550, and information from application trending database 540 to determine the list of related applications that are recommended for a user. Selection of any application listed on either application search result list 1704 or related applications display 1706 results in display of an application launch page where a user may access more detailed information about the application and initiate download of the application.

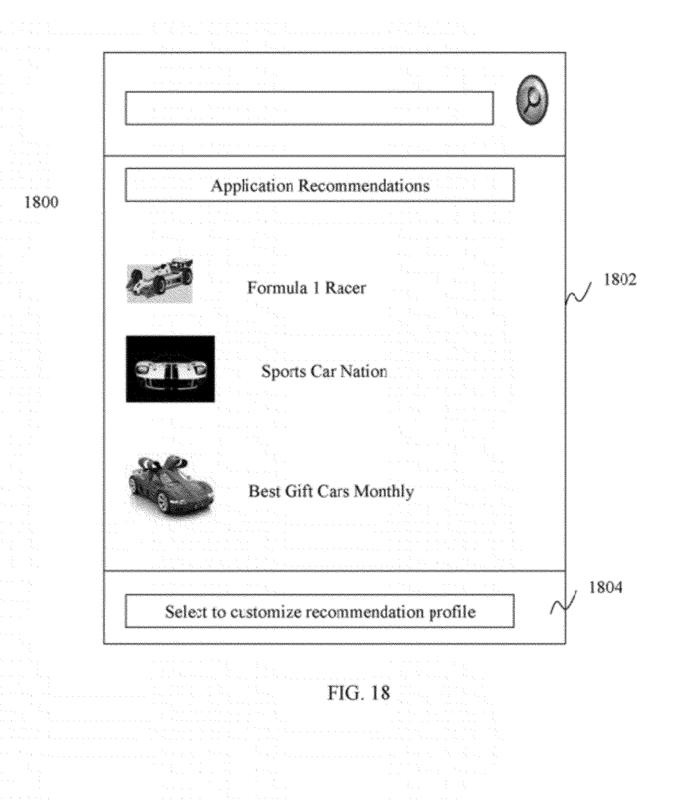

FIG. 18 depicts an exemplary screen view of an application recommendations list in accordance with an embodiment of the present disclosure. Application searching application display 1800 may display a list of application recommendations 1802 either automatically or by request from a user of the device. The application recommendations 1802 are based upon information including information obtained by application search engine 530 from user database 550 and application trending database 540. The application recommendations may be furnished on the basis of user interests, current user application usage, user application download history, and other factors that allow for personalization of application recommendations. Application searching application display 1800 also includes a customization selection icon 1804 that is actionable and selectable by a user to input preferences for what application recommendations to receive, how application recommendations are received, and what information to use as the basis for application search engine 530 to determine application recommendations 1802.

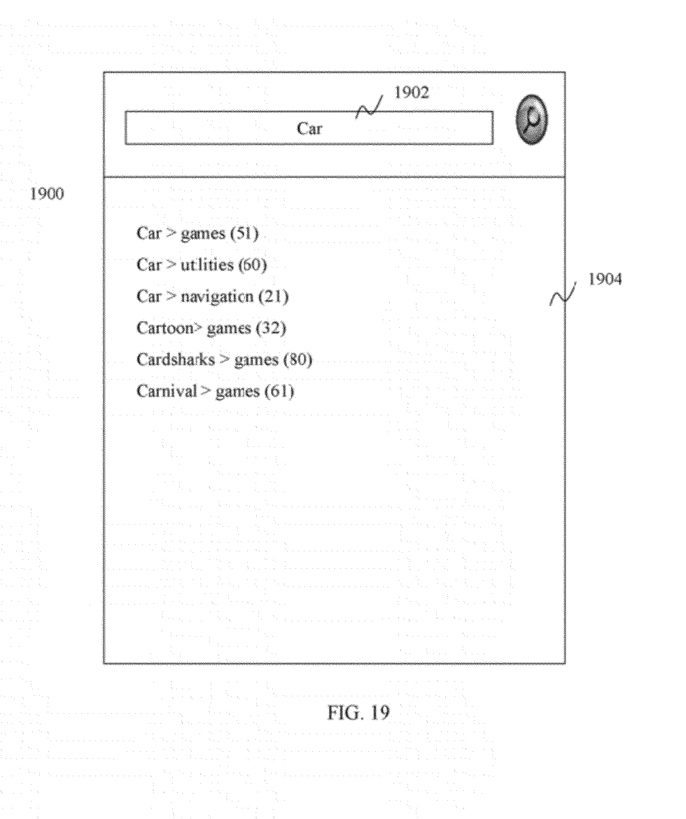

FIG. 19 depicts an exemplary screen view of an application search results list in accordance with an embodiment of the present disclosure. FIG. 19 depicts an alternate display of an exemplary application search results list in accordance with embodiments described herein. Application searching application display 1900 includes an application search query box 1902 and application search results list 1904. Application search query box 1902 for example, includes a query such as “Car” which is entered by a user of a device. Based on the entered query, application search results list 1904 is displayed. Application search results list 1904, instead of displaying results, may display categories associated with the entered search query. Application search results list 1904 may also update automatically as additional characters are entered into application search query box 1902. Selection of any of the result shown by application search results list 1904 results in a display of an application search result list associated with the selected category. Categories listed by application search results list 1904 are ordered based upon information obtained from the user, information about applications from application stores 508, and information obtained from user database 550 and application trending database 540.

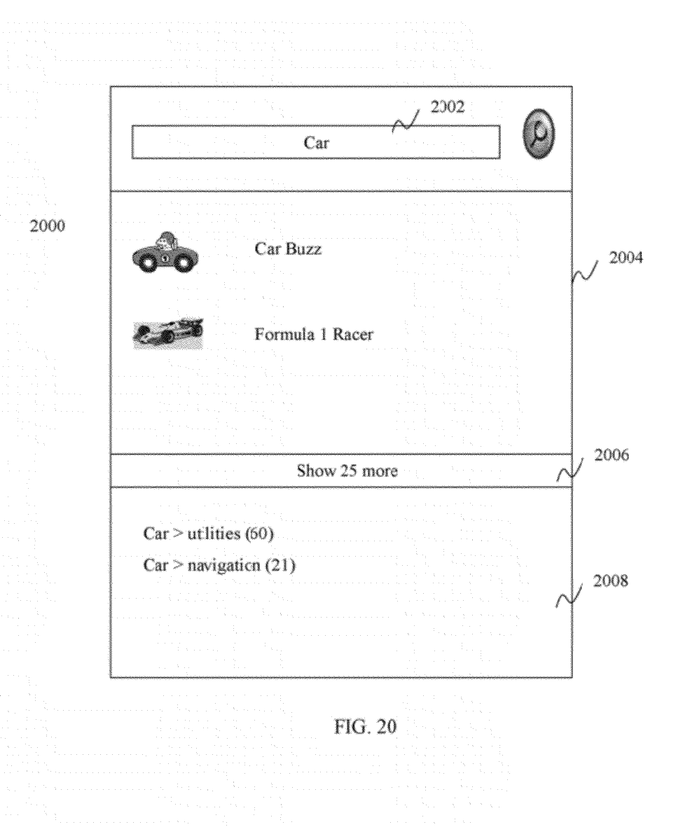

FIG. 20 depicts an exemplary screen view of an application search results list in accordance with an embodiment of the present disclosure. FIG. 20 depicts yet another alternate display of an exemplary application search results list in accordance with the embodiments described herein. Application search application display 2000 which includes application search query box 2002, application search results list 2004, additional results icon 2006, and an application search results category list 2008. Application search query box 2002 for example, includes a query such as “Car” which is entered by a user of a device. Based on the entered query, application search results list 2004 is displayed. Additional results icon 2006, when selected, allows a user to view additional search results. Also shown is application search results category list 2008 which displays categories associated with the entered search query. Selection of any of the categories causes application search results list 2004 to update based on the chosen category. Selection of any application listed on either application search result list 2004 results in display of an application launch page where a user may access more detailed information about the application and initiate download of the application.

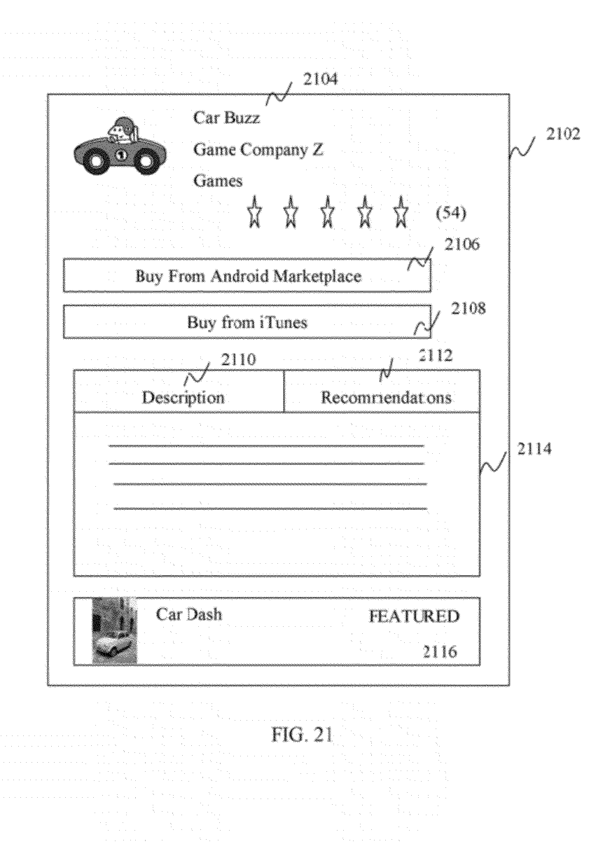

FIG. 21 depicts an exemplary screen view of an application launch page in accordance with an embodiment of the present disclosure. FIG. 21 depicts application search application display 2100 which shows a display of an application launch page after a user has selected an application from an application search results list for download. Application launch page 2102 includes application information 2104, application purchase icons 2106 and 2108, detailed application information tab 2110, application recommendations tab 2112, informational display 2114, and sponsored/featured application display 2116. Application information 2104 displays general information about the application such as the application name, application developer, application category, and application rating. Application purchase icons 2106 and 2108 are actionable by a user to facilitate purchase and/or download of the application to the user's device. Detailed application information tab 2110, when selected, causes display of detailed information about the application in informational display 2114. Application recommendations tab 2112 causes display of a list of application recommendations in informational display 2114. Sponsored/featured application display 2116 displays an application that is sponsored by a third-party provider and is presented for display based upon the current application being viewed.

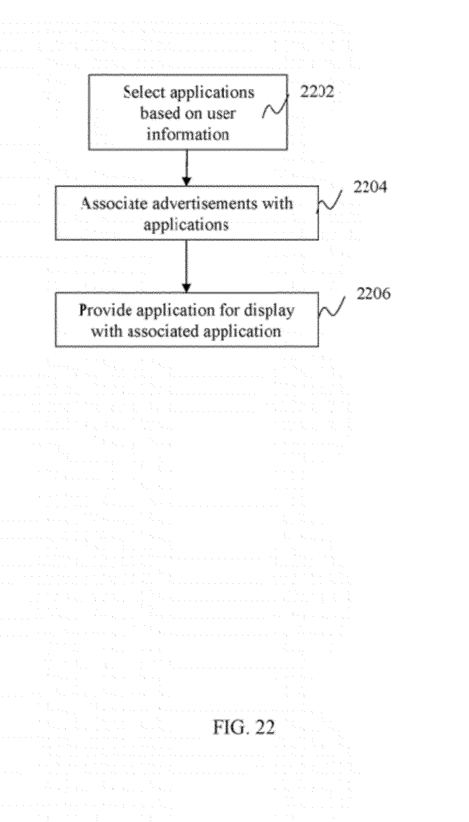

FIG. 22 depicts a flowchart of an exemplary process in which an application search engine provides applications for display with application search results, in accordance with an embodiment of the present disclosure. At 2202, at least one application is selected based on an analysis of user information. The user information can be obtained either directly from the user or from user database 550. At 2204, at least one advertisement is associated with at least one application. The advertisements are provided by a third-party information provider 560, which may be an advertiser. At 2206, application search engine 530 may provide advertisements for display when the associated application is displayed in response to an application search query submitted from a user to application search engine 530. Application search engine 530 may additionally obtain information related to presentation of advertisements, determine statistics associated with the presentation of advertisements, such as whether the advertisement was licked, viewed, or activated, update a record associated with an advertiser, and receive a payment from an advertiser based on presentation of the advertisement.

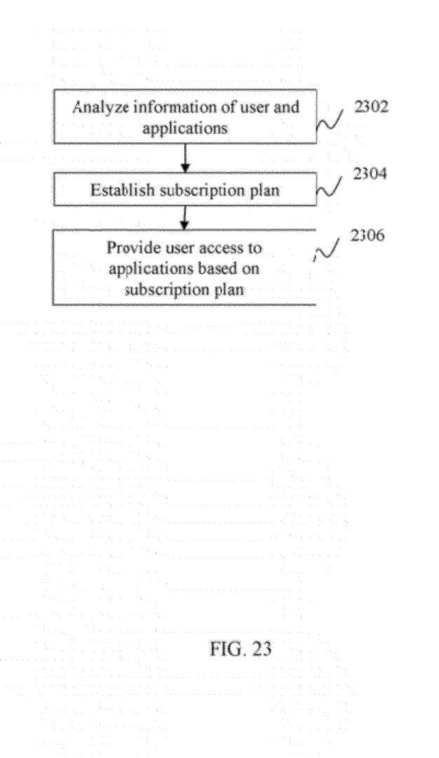

FIG. 23 depicts a flowchart of an exemplary process in which an application search engine establishes subscription plans allowing users to access applications, in accordance with an embodiment of the present disclosure. At 2302, information associated with a user and information associated with applications are analyzed by application search engine 530 At 2304, based on the analysis of this information, a subscription plan may be established allowing a user access to applications in accordance with predetermined terms. The predetermined terms may be established by a third party, such as a cellular network provider, application store, advertiser, or other partner.

At 2306, the user is provided access to the applications based on the subscription plan that is established. Subscription plans, as stated, are established base upon predetermined terms including fees for the subscription plan, a number of applications, an incentive fee, and awards that may be provided based on user usage of the applications. Subscription plans may allow provision of certain applications based on certain characteristics of a user or of a user device. For example, if a user is using a certain mobile phone, they may be able to sign up for a subscription plan that provides discounts for application purchases.

To implement the embodiments set forth herein, computer hardware platforms may be used as hardware platform(s) for one or more of the elements described herein. The hardware elements, operating systems and programming languages of such computer hardware platforms are conventional in nature, and it is presumed that those skilled in the art are adequately familiar therewith to adapt those technologies to implement any of the elements described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment, and as a result the drawings are self-explanatory.

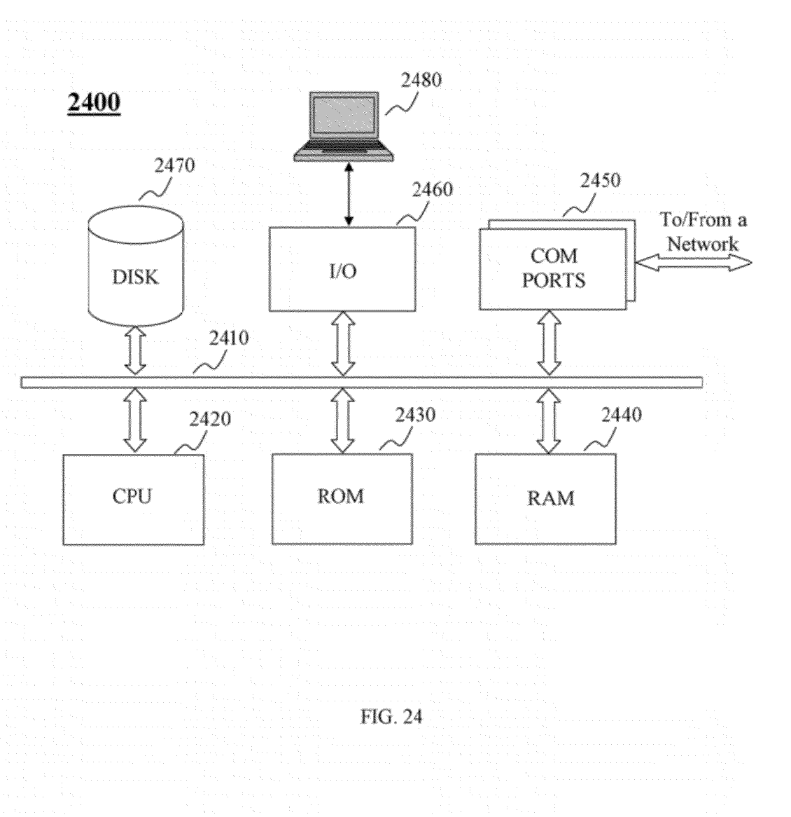

FIG. 24 depicts a general computer architecture on which the present teaching can be implemented and has a functional block diagram illustration of a computer hardware platform which includes user interface elements. The computer may be a general purpose computer or a special purpose computer. This computer 2400 can be used to implement provision of application search results, advertisements, recommendations, and subscription plans described herein. For example, the components of application search engine 530 can all be implemented on a computer such as computer 2400, via its hardware, software program, firmware, or a combination thereof. Although only one such computer is shown, for convenience, the computer functions relating to development and hosting of applications may be implemented in a distributed fashion on a number of similar platforms, to distribute the processing load.

The computer 2400, for example, includes COM ports 2450 connected to and from a network connected thereto to facilitate data communications. The computer 2400 also includes a central processing unit (CPU) 2420, in the form of one or more processors, for executing program instructions. The exemplary computer platform includes an internal communication bus 2410, program storage and data storage of different forms, e.g., disk 2470, read only memory (ROM) 2430, or random access memory (RAM) 2440, for various data files to be processed and/or communicated by the computer, as well as possibly program instructions to be executed by the CPU. The computer 2400 also includes an I/O component 2460, supporting input/output flows between the computer and other components therein such as user interface elements 2480. The computer 2400 may also receive programming and data via network communications.

Hence, aspects of the methods of developing, deploying, and hosting applications that are interoperable across a plurality of device platforms, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated schedules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a server or host computer into the hardware platform(s) of a computing environment or other system implementing a computing environment or similar functionalities in connection with generating application search results. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media includes dynamic memory, such as a main memory of such a computer platform. Tangible transmission media includes coaxial cables, copper wire, and fiber optics, including wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic take, any other magnetic medium, a CD-ROM, DVD or DVD-ROM, any other optical media, punch card paper tapes, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the embodiments of the present disclosure are amenable to a variety of modifications an/or enhancements. For example, although the implementation of various components described above may be embodied in a hardware device, it can also be implemented as a software only solution —e.g. an installation on an existing server. In addition, the dynamic relation/event detector and its components as disclosed herein can be implemented as firmware, a firmware/software combination, a firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim and all applications, modifications and variations that fall within the true scope of the present teachings.

1. A method implemented on at least one computing device, each computing device having at least one processor, storage, and a communication platform connected to a network for providing adaptive application searching, the method comprising:
receiving an application search request relevant to a user;
obtaining first information associated with the user and second information associated with a plurality of applications;
identifying at least one application of the plurality of applications of interest based on the application search request, the first information, and the second information; and
providing the at least one application as a response to the application search request.

2. The method of claim 1, wherein the application search request includes at least one of: a query originating from the user or an automatically initiated application search request.

3. The method of claim 1, wherein the first information includes at least one of:
user device information, a profile associated with the user, trending data associated with the user, and past behavior data of the user with respect to usage of applications.

4. The method of claim 1, wherein providing the at least one application comprises:
filtering the identified at least one application based on criterion comprising at least one of: user social networking groups, user device location, user personal contacts, and user personal relationship data.

5. The method of claim 1, further comprising:
causing the at least one application to be automatically installed on a device associated with the user.

6. A machine readable non-transitory and tangible medium having information recorded for providing adaptive application searching, wherein the information, when read by the machine, causes the machine to perform the steps comprising:
receiving an application search request relevant to a user;
obtaining first information associated with the user and second information associated with a plurality of applications;
identifying at least one application of the plurality of applications of interest based on the application search request, the first information, and the second information; and
providing the at least one application as a response to the application search request.

7. The machine readable non-transitory and tangible medium of claim 6, wherein the application search request includes at least one of: a query originating from the user or an automatically initiated application search request.

8. The machine readable non-transitory and tangible medium of claim 6, wherein the first information includes at least one of: user device information, a profile associated with the user, trending data associated with the user, and past behavior data of the user with respect to usage of applications.

9. The machine readable non-transitory and tangible medium of claim 6, wherein the step of providing the at least one application comprises:
filtering the identified at least one application based on criterion comprising at least one of: user social networking groups, user device location, user personal contacts, and user personal relationship data.

10. The machine readable non-transitory and tangible medium of claim 6, wherein the machine further performs the steps comprising: causing the at least one application to be automatically installed on a device associated with the user.

11. A system providing adaptive application searching, comprising:
a search engine for receiving an application search request relevant to a user;
a user database storing first information associated with the user;
an application trend database storing second information associated with a plurality of applications;
an application search engine for identifying at least one application of the plurality of applications of interest based on the application search request, the first information, and the second information, and providing the at least one application as a response to the application search request.

12. The system of claim 11, wherein the application search request includes at least one of: a query originating from the user or an automatically initiated application search request.

13. The system of claim 11, wherein the first information includes at least one of:
user device information, a profile associated with the user, trending data associated with the user, and past behavior data of the user with respect to usage of applications.

14. The system of claim 11, wherein the application search engine is configured to filter the identified at least one application based on criterion comprising at least one of:
user social networking groups, user device location, user personal contacts, and user personal relationship data.

15. The system of claim 11, wherein the application search engine is configured to cause the at least one application to be automatically installed on a device associated with the user.

16. A method implemented on at least one computing device, each computing device having at least one processor, storage, and a communication platform connected to a network for presenting advertisements, the method comprising:
selecting at least one application based on user information;
associating at least one advertisement with the at least one application; and
providing the at least one advertisement for display when the at least one application is displayed in response to an application search query from a user associated with the user information.

17. The method of claim 16, further comprising:
obtaining information related to presentation of the at least one advertisement associated with the at least one application;
determining statistics associated with the presentation;
updating a record associated with an advertiser based on the statistics;
receiving a payment associated with the at least one advertisement based on the updated record.

18. A method implemented on at least one computing device, each computing device having at least one processor, storage, and a communication platform connected to a network for providing sponsored application searching, the method comprising:
obtaining first information associated with a user;
obtaining second information associated with at least one application provided by a sponsor;
selecting at least one application relevant to the user based on the first information and the second information;
obtaining third information associated with activity of the user with respect to the selected at least one application;
providing the third information to the sponsor for analysis; and
providing a list of additional applications to the user based on the analyzed third information.

19. The method of claim 18, wherein the sponsor is at least one of: an application developer, an application repository, an application distributor, and an application dealer.

20. A method implemented on at least one computing device, each computing device having at least one processor, storage, and a communication platform connected to a network for providing applications to a user, the method comprising:
analyzing first information associated with a user and second information associated with at least one application;
establishing a subscription plan allowing the user to access the at least one application in accordance with predetermined terms based on the analyzing; and
providing the user access to the at least one application based on the subscription plan.

21. The method of claim 20, wherein the predetermined terms comprise at least one, of: a fee for the subscription plan, a number of applications allowed by the subscription plan, an incentive program, and awards to be provided, based on conditions associated with usage of the applications.
